(19) United States
(12) Patent Application Publication
(10) Pub. No.: US 2009/0255910 A1
(43) Pub. Date: Oct. 15, 2009

(54) LASER MACHINING SYSTEM WITH PROTECTIVE ENCLOSURE

(76) Inventor: Ulf Feistel, Laasdorf (DE)

Correspondence Address: DUANE MORRIS LLP - NY;PATENT DEPARTMENT, 1540 BROADWAY, NEW YORK, NY, 10036-4086, US

(21) Appl. No.: 12/418,966

(22) Filed: Apr. 6, 2009

(30) Foreign Application Priority Data
Apr. 11, 2008 (DE) 10 2008 019 095.0

(51) Int. Cl. B23K 26/38

(52) U.S. Cl. 219/121.67

(57) ABSTRACT

The present invention relates to a laser machining system with a protective enclosure wherein the protective enclosure is basically formed by a protective hood which encloses a workpiece that is mounted on a mounting device in such a manner that a laser head can be moved within the protective hood through the slit-shaped opening by means of a robot arm.

### FIELD OF THE INVENTION

The present invention relates generally to laser machining systems and more particularly to a laser machining system with a protective enclosure in which the protective enclosure is formed by a protective hood which encloses a workpiece mounted on a mounting device in such a manner that a laser head can be moved by means of a robot arm.

### BACKGROUND OF THE INVENTION

In addition to the functional units that are vital to the operation of laser machining systems, such as a laser beam source, means for delivering the laser beam to the site to be machined and a device for mounting a workpiece that is to be machined, such laser machining systems generally also comprise means for discharging waste gases that are generated in the course of the laser machining process as well as means for protecting (protective enclosure) the operating personnel from laser radiation.

The relative movement between the laser beam as the tool and the workpiece, which movement is required to produce a desired cut or weld line, can be carried out either by the tool or by the workpiece.

In laser machining systems in which the tool is moved by a machine, the means for delivering the laser beam can generally be divided into those in which a laser head is moved in two dimensions on a stationary machine gantry and those in which the laser head is moved in three dimensions in space on the free end of a robot arm. The laser beam can be delivered from the laser beam source to the laser head via a separate beam delivery system or, in case of robot guidance, through the robot arm.

Especially in the last-mentioned embodiment, there is always the risk that, due to faulty robot control, the laser beam is not directed onto the workpiece as intended.

To avoid such risks, protective enclosures are used.

It is standard practice to enclose the robot within laser protection screens that are spacious enough to entirely accommodate the robot so that the laser head which is moved on the free end of the robot arm can follow the paths of motion required to carry out the machining operation within the laser protection cabin that is formed by the laser protection screens.

The laser protection screens used can be both passive and active laser protection screens. Active laser protection screens cause the laser beam to be switched off as soon as such a beam impinges on the laser protection screen or penetrates a double-walled sensor-monitored protection screen, i.e., the laser beam automatically switches itself off. To this end, the laser protection screen must obviously be designed so as to be able to withstand the laser radiation for at least a short time.

A laser protection cabin that completely encloses all functional units required for the laser machining system is not only expensive in terms of the material needed and requires considerable space, it also entails a large exhaust volume in conformity with the enclosed inside space.

DE 297 16 008 U1 discloses a safety screen system of a laser machining system in which the laser head, which is moved by means of a guide carriage on a machine gantry, is covered by a protective hood, thus enclosing the area that is being machined. Such a protective hood is very useful if the laser head moves only in one plane that is bounded by the crossbeam and the longitudinal beam of a machine gantry.

However, such a protective hood, which is rigidly affixed to the laser head, is not suitable if the laser head on a robot arm is moved in three dimensions in space in order to describe an intended path of motion.

EP 0 962 278 A2 also discloses a laser cutting system with a safety screen in which a protective hood is attached to a movable machine gantry and thus, in any working position, encloses a laser cutting head that can be moved on a crossbeam of the machine gantry at right angles to the traversing direction.

Again, this solution is useful only for systems in which the machine gantry moves the laser cutting head relative to the workpiece.

DE 196 36 458 C1 discloses a portable system for laser welding which can be manually positioned and operated. The system comprises a protective hood which, in different predetermined positions, is successively placed on a planar workpiece so that a laser beam welding head that can move along a linear drive axis in the protective hood can be moved relative to the workpiece, e.g., along segments of an overlapping weld seam. The relative movement required between the laser welding head and the workpiece is implemented by the manual transport motion of the protective hood and the straight linear movement of the laser head on the drive axis.

The system disclosed in this document is unsuitable for machining motions that deviate from a straight-line motion or for workpieces on which the protective hood cannot be placed so that it rests flat thereon.

### SUMMARY OF THE INVENTION

The problem to be solved by the present invention is to make available a laser machining system with a space-saving protective enclosure, by means of which a three-dimensional workpiece can be machined by a robot-controlled laser beam.

This problem is solved by a system with the features of claim 1. Useful further developments are described in the dependent claims.

The invention is based on the idea of limiting the range of motion of the robot-controlled laser head to the paths of motions intended to be machined, regardless of any faulty robot control, so as to reduce the area of risk, thereby making it possible to reduce the space enclosed by the protective enclosure.

The paths of motion can be limited, on the one hand, by monitoring the position of the laser head relative to the protective enclosure by means of contact sensors or distance sensors and by switching off the laser when such a contact sensor is actuated or if signals that differ from the predetermined theoretical values are detected.

On the other hand, the freedom of movement of the laser head can be limited by the constructive design of a protective enclosure that conforms to the paths of motions, thereby ensuring laser safety even without sensors or with a reduced number of sensors.

Since the risk of faulty measurements is inherent in the first embodiment and since, furthermore, errors in the robot control can arise, it is recommended that the two embodiments be combined.

Although a limitation of the freedom of movement by an appropriate mechanical design, as offered by the second embodiment, effectively prevents a faulty orientation of the laser beam to the greatest possible extent, it can also lead to mechanical damage, especially to the laser head, and should therefore be used only as a last resort to overcome the safety hurdle.

A protective enclosure according to the present invention is constructed to ensure that a protective hood in combination with a system carrier completely encloses a workpiece that is positioned on a mounting fixture. To this end, the edge of the protective hood and the edge of the system carrier are positioned so as to sit close to each other.

The protective hood has at least one opening, through which the laser head, at a predetermined distance from a workpiece that is positioned on a mounting fixture, said laser head being held by the robot arm, can describe an intended path of motion inside the protective enclosure so as to generate a machining line, e.g., a cut perforated or weld line, in the workpiece.

The openings have the shape of slits, the size of which is kept to a minimum, thereby ensuring that although the laser head can pass through the openings, the resulting openings for the discharge of waste gases are kept at the minimum size possible.

It is recommended that the height of the protective hood in an area around an opening be dimensioned in such a manner that the distance between the opening and the workpiece is larger than the laser head so that the laser head can be completely inserted into the protective hood.

At least one end, preferably both ends, of the slit-shaped opening must be dimensioned large enough to ensure that the laser head can pass through. Between the two ends, the opening can be narrower so that only the end of the robot arm can be moved in the opening while the laser head cannot pass through.

It is recommended that the two larger dimensioned end regions not be located above the intended machining line so that the laser beam must be directed via the laser head onto the workpiece only after the laser head has been moved below the narrower dimensioned region of the opening. This ensures that the laser head is activated, i.e., that the laser beam is directed via the laser head onto the workpiece only once the laser head is located below the opening regions, through which it cannot be lifted out of the protective hood.

This type of mechanical safeguard is not possible unless the circumference of the laser head is larger than the adjacent end of the robot arm.

In this case, a surface enlargement, e.g., by means of a cuff that is additionally wrapped around the circumference of the laser head, with a dimension larger than the cross section of the end of the robot arm might offer a solution to the problem of the mechanical safeguard described.

Instead of using the top surface of the laser head or its surface enlargement as a potential stop face for the protective hood, an additional mechanical stop can be disposed on the laser head, which stop is folded out and secured only after the laser head has been lowered.

As an alternative or in addition thereto, sensors should be used as a safeguard, which sensors can be attached to the laser head or to the end of the robot arm or to the protective hood around the openings.

To this end, it is useful to provide contact sensors which detect contact between the laser head or the end of the robot arm and the protective hood, in particular the lateral walls of the opening. Similarly, distance sensors can be used to detect a deviation of the laser head from its predetermined path of motion.

The laser head can also be designed as a hidden laser head. In this case, it can be temporarily positioned in a start position on the side of the bottom opening of the protective hood under the slit-shaped opening, and the robot arm can subsequently be coupled to the laser head by passing it through the opening. This embodiment completely precludes the possibility that the laser head is pulled out of the protective enclosure.

### BRIEF DESCRIPTION OF THE DRAWINGS

The system will be described in greater detail, using examples with reference to the annexed drawings in which:

FIG. 1 is a sectional view through a first embodiment of the system according to the present invention;

FIG. 2 is a sectional view through a second embodiment of the system according to the present invention;

FIG. 3a is a top view of a first embodiment of a protective hood;

FIG. 3b is a top view of a second embodiment of a protective hood;

FIG. 3c is a top view of a third embodiment of a protective hood; and

FIG. 3d is a top view of a fourth embodiment of a protective hood.

### DESCRIPTION OF AN EMBODIMENT

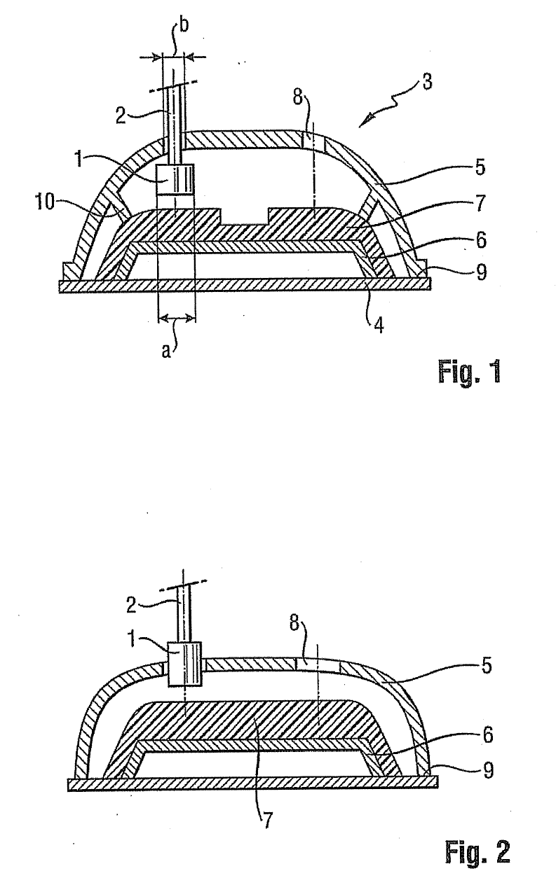

FIG. 1 shows a section through a useful embodiment of a laser machining system. It basically comprises a laser radiation source (not shown), a robot of which only the end of the robot arm 2 is seen and to which a laser head 1 is attached, a system carrier 4 and a protective hood 5.

The system carrier 4 and the protective hood 5 are joined along edge 9 and, except for the slit-like openings 8 in the protective hood 5, thus form a closed protective enclosure 3. Mounted on the system carrier 4 is a mounting device 6 on which a workpiece 7 is mounted. The protective hood 5 is preferably fitted with hold-down devices 10 which affix the workpiece 7 to the mounting device 6.

As FIG. 1 illustrates, the protective hood 5 in combination with the system carrier 4 completely encloses the workpiece 7 in such a manner that the free volume under the protective cover 5 is small, yet the laser head 1 can move entirely inside the protective hood 5 under the openings 8 at a predetermined distance from the workpiece 7.

A small free volume inside the protective enclosure has the advantage that only a small exhaust volume must be evacuated by means of an exhaust system (not shown).

A connection or preferably a plurality of connections between the protective enclosure and the exhaust system is/are preferably disposed in the vicinity of the openings 8 in order to prevent, to the greatest extent possible, the waste gases from escaping through the openings 8 as a result of the low pressure generated by the exhaust system.

In this first embodiment which is shown in FIG. 1, size ‘a’ of the cross section of the laser head 1 in the direction of width ‘b’ of the slit-shaped opening 8 is greater than width ‘b’.

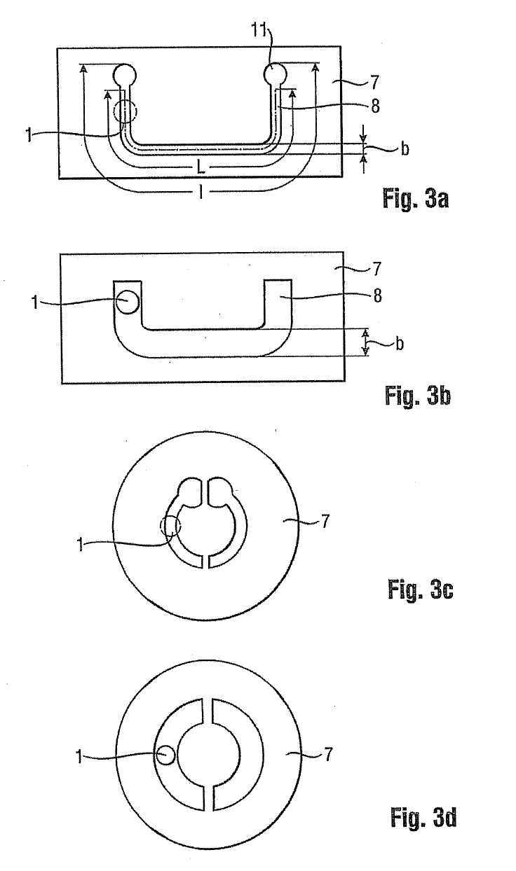

Examples of such a slit design are illustrated in FIGS. 3a and 3c.

In FIG. 3a, opening 8 is a U-shaped slit, the two ends of which have expansions. To machine the workpiece 7, the laser head is inserted through one of the expansions 11 until the laser head reaches a predetermined distance from the workpiece under the protective hood 5. At this distance, the laser head 1 is subsequently moved across the workpiece 7 along the narrower region of opening 8 and, in the end, is lifted out through expansion 11 on the other end.

Since the intended machining line 2 does not begin or end immediately below the expansions 11, the laser head 1 is active only once it is located below the smaller region of opening 8. This means that if, during the actual machining operation, faulty robot control causes the laser head 1 to deviate from the path, either the laser head 1 itself will strike against the inside surface of the protective hood 5 or the robot arm 2 will strike against the side walls of the opening 8.

The mechanical stops thus provided prevent the laser head 1 from occupying unintended positions which could expose the operating personnel to the risk of laser radiation. It is recommended that at least one sensor be disposed on the laser head 1 or a plurality of sensors be disposed along the opening 8 on the protective hood 5. Such sensors can be, in particular, pressure sensors or electrical contact sensors which detect contact and the signals of which cause the laser radiation source to be switched off and thus deactivate the laser head 1 and the robot.

A slit configuration as shown in FIG. 3a can be useful, e.g., for machining a cut or perforated line into an airbag cover.

Based on the protective hood 5 shown in FIG. 3c, the workpiece 7 might be, e.g., a steering wheel cap into which a circular perforated line is to be machined as a predetermined rupture line. The two mirror-symmetric openings 8 are separated by joining strips which connect the protective hood's 5 inside and outside areas that are separated by the openings 8.

In conformity therewith, the resulting theoretical rupture line also has unmachined joining strips, or in order to be able to also machine the line regions covered by the joining strips, the laser head 1 is swiveled so as to ensure that the laser beam also impinges on the workpiece underneath the joining strips. To this end, the laser had 1 can be connected with the robot arm 2 by way of a single hinged joint.

It can be of advantage for the laser head 1 to be connected with the robot arm 2 by way of a double hinged joint, which would make it possible for the laser beam to be directed onto the workpiece 7 in such a manner that the beam is offset parallel with respect to the lateral edges of the opening 8 and the escape of scattered radiation through the opening 8 is prevented. It is obvious to the person skilled in the art that the terms single and double hinged joints do not refer to purely mechanical joints but that in these joints, the laser beam as well is deflected about one or two axes by means of suitable optical elements. It would also be possible to use a laser head 1 which itself has an angled configuration.

The protective hoods 5 shown in FIGS. 3b and 3d have slit-shaped openings 8 with a constant width b along their entire length 1. The width b is dimensioned large enough for the laser head 1 to be moved in the opening 8, i.e., the laser head is only partially inserted into the protective enclosure 3, as shown in FIG. 2, which ensures a mechanical barrier only with respect to horizontal deviations of movements. To create a mechanical barrier in the vertical direction as well, a mechanical swing-out stop (not shown in the drawings), which prevents the laser head from being accidentally lifted out, is disposed on the laser head 1. In this embodiment, the shape of the protective hood 5 can be flatter, which further reduces the exhaust volume.

The length 1 of an opening 8 shown in FIG. 3b preferably conforms to the length L of the intended machining line, except for a minor addition in length due to the structural dimensions of the laser head 1.

The expansions shown in FIGS. 3a and 3c are not needed if the laser head 1 is inserted into the protective enclosure 3 from the lateral edge of the protective hood 5 and is coupled to the robot arm 2 through the opening 8. This solution ensures absolute safety even if the robot control and even the sensors on the laser head 1 and/or on the protective hood 5 were to fail since the laser head 1 at no point fits through the opening 8.

To prevent the escape of scattered radiation past the laser head 1 through the opening 8, a protective shield can be attached to as to surround the laser head 1.

The layout of the protective enclosure can be horizontal as in FIGS. 1 and 2 but any useful spatial configuration is possible as well.

### LIST OF REFERENCE SYMBOLS

a Size of the cross section of the laser head in the direction of width b
b Width of the opening
l Length of the slit-shaped opening
L Length of the intended machining line
1 Laser head
2 Robot arm
3 Protective enclosure
4 System carrier
5 Protective hood
6 Mounting device
7 Workpiece
8 Slit-shaped opening
9 Edge of the protective hood
10 Holding-down devices
11 Expansion
12 Machining line

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

1. A laser machining system with a protective enclosure comprising, a laser radiation source, a robot having a robot arm and a laser head mounted on a free end of said robot arm wherein a laser beam is delivered from said laser radiation source to said laser head, a mounting device for a workpiece that is to be machined, a protective enclosure connected to an exhaust system, said protective enclosure being formed by a system carrier on which said mounting device is positioned, and a protective hood having a predetermined height, the circumferential edge of said protective hood being positioned against said system carrier, said protective hood having at least one slit-shaped opening through which said laser head is moved at a predetermined distance along a predetermined path of motion which determines the course of a machining line and conforms to the shape and length of said slit-like opening so as to machine said workpiece.

2. The laser machining system with a protective enclosure as in claim 1, wherein at least in the region of said opening, the height of the protective hood is dimensioned in such a manner that the laser head can be moved entirely within the protective hood.

3. The laser machining system with a protective enclosure as in claim 1, wherein the shape of the protective hood conforms to the surface shape of the workpiece so that the free volume of the protective enclosure may be kept to a minimum.

4. The laser machining system with a protective enclosure as in claim 2, wherein the width of said slit-shaped opening is smaller than the cross section of the laser head in the direction of said width of said slit-shaped opening and that an expansion is formed at least on one end of said slit-shaped opening so as to male it possible, at said end, to insert said laser head into and withdraw it from said protective enclosure.

5. The laser machining system with a protective enclosure as in claim 4, wherein said slit-shaped opening comprises expansions on both of its ends so as to insert the laser head on one end into the protective enclosure and to withdraw it on the other end from the protective enclosure.

6. The laser machining system with a protective enclosure as in claim 2, wherein along the entire length of said slit-shaped opening, the width of said opening is smaller than the size of the cross section of the laser head in the direction of said width of said slit-shaped opening, with the laser head being inserted from the lateral edge of the protective hood into the protective hood and with the robot arm being coupled to the protective hood through the slit-shaped opening.

7. The laser machining system with a protective enclosure as in claim 4, wherein the length of the slit-shaped opening, including said expansion is longer than the predetermined length of the path of motion and thus of said machining line.

8. The laser machining system with a protective enclosure as in claim 4, wherein the size of the cross section of said laser head is determined by a cuff that encloses said laser head.

9. The laser machining system with a protective enclosure as in claim 1, further comprising sensors which detect the distance or contact with the lateral wall of the opening disposed on said laser head or on the end of the robot arm, depending on which of the two components moves in the opening.

10. The laser machining system with a protective enclosure as in claim 6, further comprising a protective shield attached to said laser head so as to avoid the escape of scattered radiation through said opening.

11. The laser machining system with a protective enclosure as in claim 2, wherein said laser head is angled so that the machining line parallel to the lateral edge of the slit-shaped opening is not produced below the opening, thereby limiting the escape of scattered radiation.
